(19) United States
(12) Patent Application Publication
(10) Pub. No.: US 2012/0306195 A1
(43) Pub. Date: Dec. 6, 2012

(54) High Rotation Linkage Attachment for Hydraulic Lines

(75) Inventors: Andrew R. Fowkes, Clayton, NC (US); Lee Evans, Selma, NC (US); William Glisson, JR., Goldsboro, NC (US); Kelvin T. Gibbs, Selma, NC (US)

(73) Assignee: CATERPILLAR, INC., Peoria, IL (US)

(21) Appl. No.: 13/149,126

(22) Filed: May 31, 2011

(51) Int. Cl. F16L 37/52; B23P 11/00

(52) U.S. Cl. 285/147.1; 29/428

(57) ABSTRACT

A work machine and work implement for a work machine are disclosed with a hydraulic system enabling greater rotation of the work implement relative to the work machine without providing excess hydraulic line to accommodate such rotation. More specifically, the work machine may include a first hydraulic fluid line extending from a pump of the work machine along a work arm pivotally attached to the work machine, and a second hydraulic fluid line extending from the work implement toward the work arm. The hydraulic swivel coupling may be provided at the a pivot point between the work arm and the work implement where the first and second hydraulic fluid lines can be connected to the hydraulic swivel coupling.

### FIELD OF THE DISCLOSURE

The present disclosure generally relates to hydraulics, and more particularly relates to rotational couplings for hydraulic lines.

### BACKGROUND OF THE DISCLOSURE

Work machines employing hydraulic power are common. Such machines can be extremely large excavators, pipe layers, track-type tractors or the like, or can be relatively small loaders, forklifts, skid steers or the like. In each of these applications, the work machine includes a chassis upon which is mounted a power source such as a diesel engine which drives a pump for providing hydraulic fluid to various portions of the work machine. The pump may provide hydraulic fluid to primary and secondary receivers of the hydraulic fluid such as hydraulic cylinders for raising and lowering work arms pivotally attached to the work machine, or tilting or otherwise turning the work implement attached to the work arm. For example, a bucket is commonly attached to a work arm which in turn is connected to the work machine such that earth or other cargo can be loaded into and dumped from the bucket of the machine.

Many attachments or work implements attached to the work arms of such machines also require additional sources of hydraulic fluid. Such additional needs are often referred to as third functions or even fourth or fifth functions depending on the complexity of the work implement attached to the machine. For example, grappling hooks can be attached to the end of the work arms with the operator of the machine being provided with controls for manipulating the grappling arms. Accordingly, hydraulic fluid needs to be provided from the pump of the machine to the work implement in third function lines such as rigid conduit or flexible hose. Moreover, such implements often need to rotate a significant degree relative to the work arms. As a result, the hydraulic fluid lines run to the work implements are often provided with a significant degree of slack in the lines so as to allow for such rotation. While this is effective, when the work implement is rotated in a first direction, the excess line is taken up but, in the opposite direction, a significant amount of sag or droop is provided in the hydraulic fluid lines. This sag in the hydraulic fluid lines often drags on the ground over which the machine traverses. In addition, the excess fluid line can often become snagged or otherwise entangled in the work arms of other moving equipment of the work machine. In either case, the line is subjected to significant wear and tear, and can possibly interrupt hydraulic power. In extreme cases, the line can even rupture.

In light of this, it can be seen a need exists for a hydraulic system for work machines which lessens slack in the hydraulic fluid lines, while still enabling full rotation of the work implements and uninterrupted use of third function operations.

### SUMMARY OF THE DISCLOSURE

In accordance with one aspect of the disclosure, a work machine is disclosed which may comprise a chassis, a work arm pivotally attached to the chassis at a first pivot point, a work implement pivotally attached to a work arm at a second pivot point, a hydraulic fluid pump supported by a chassis, a first hydraulic fluid line extended from the pump to a second pivot point, a second hydraulic fluid line extended from the work implement to the second pivot point, and a hydraulic swivel coupling at the second pivot point, the first and second hydraulic fluid lines being connected to the hydraulic swivel coupling.

In accordance with another aspect of the disclosure, a work implement is disclosed which is adapted for connection to a work machine having a source of hydraulic fluid. The work implement may comprise a pivot point connected to a work machine, a third function tool operatively associated with the implement and adapted to employ hydraulic fluid, a hydraulic fluid line extending from the tool to the pivot point, and a hydraulic swivel coupling connected to the hydraulic fluid line at the pivot point.

In accordance with yet another aspect of the disclosure, a method of connecting work implements to a hydraulic fluid source of a work machine is disclosed which may comprise extending a first hydraulic fluid line from a hydraulic fluid pump to a pivot point between the work machine and the work implement, extending a second hydraulic fluid line from a component of the work implement needing hydraulic fluid to the pivot point, and interconnecting the first and second lines with a hydraulic swivel coupling at the pivot point.

These and other aspects and features of the disclosure will become more apparent upon reading the following detailed description when taking a conjunction with the accompanying drawings.

### BRIEF DESCRIPTION OF THE DRAWINGS

FIG. 1 is a perspective view of a work machine constructed in accordance with the teachings of the disclosure;

FIG. 2 is an enlarged perspective view of a work arm and implement interface showing the hydraulic swivel coupling of the present disclosure in a fully racked position;

FIG. 3 is an enlarged perspective view similar to FIG. 2, but showing the implement in a first intermediate position;

FIG. 4 is an enlarged perspective view similar to FIG. 2, but showing the implement in a second intermediate position;

FIG. 5 is an enlarged perspective view similar to FIG. 2, but showing the implement in a fully dumped position;

FIG. 6 is a perspective view of a hydraulic swivel coupling constructed in accordance with the present disclosure.

While the following detailed description will be made in reference to certain illustrative embodiments, it is to be understood that the teachings of the disclosure are not to be limited thereby, but are rather to be construed in light of the claims eventually appended hereto and their equivalents.

### DETAILED DESCRIPTION OF THE DISCLOSURE

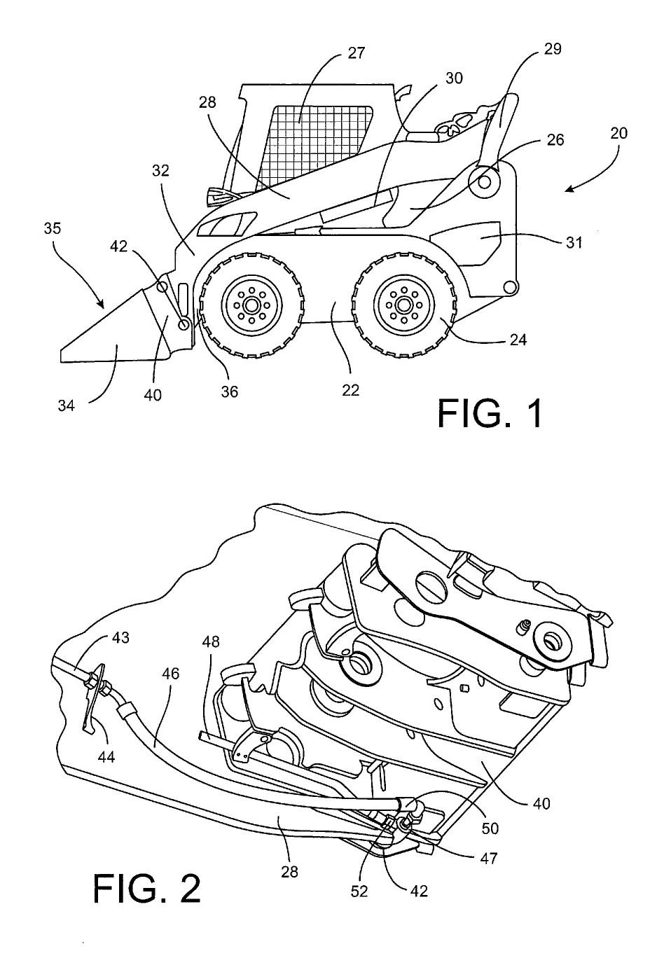

Referring now to the drawings, and with specific reference to FIG. 1, a work machine constructed in accordance with the teachings of the disclosure is generally referred to by reference numeral 20. While the work machine 20 is depicted in FIG. 1 and described herein as a loader, it is to be understood that the teachings of the disclosure can be used in conjunction with a number of other work machines including, but not limited to, loaders, excavators, compactors, track-type tractors, skid steers, telehandlers, pipe layers, and motor graders.

As shown in FIG. 1, the work machine 20 may include a chassis 22 supported by wheels 24. Of course, in alternative embodiments, the wheels 24 may be replaced by tracks or other forms of locomotion devices. The chassis 22 in turn supports an engine 26 such as a diesel engine or other form of prime mover including, but not limited to, internal combustion engines and electric drive trains. The chassis 22 may also support an operator cabin, seat or station 27.

A work arm or pair of work arms 28 are pivotally attached to the chassis 22 at a first pivot point 29. The work arms 28 are moved by hydraulic cylinders 30. A hydraulic pump 31 may be in fluid communication with the hydraulic cylinders 30 to raise and lower the work arms 28 in what is referred to as a first hydraulic function.

At a distal end 32 of the work arm 28, a work implement 34 is pivotally attached. The work implement 34 is depicted as a bucket, but it is to be understood that the work implement 34 may be, but is not limited to, any number of different implements such as augers, blades, brooms, buckets, cold planers, couplers, cutters, forks, handlers, grapplers, plows, rakes, thumbs, vibratory compactors, shears, rippers, scoops, backhoes, brushcutters, mulchers, snow blowers, stump grinders, tillers, trenchers, wheel saws, carriages, lifting hooks, hoppers, winches and scarifiers. A second hydraulic cylinder 36 connected between the work arm 28 and work implement 34 may cause the implement to rotate relative to the work arm 28 and in so doing this is referred to as a second hydraulic function.

Certain of the aforementioned implements 34 may be designed to have intricate movements performed by third function tools 35. The hydraulic power used to perform these movements is referred to as a third hydraulic function, or depending on the complexity of the operation a fourth, fifth or so on hydraulic function. For example, a grappler (not shown) may have additional fingers that are movable by hydraulic fluid in addition to being rotatable relative to the work arm 28. With prior art devices, such third order hydraulic functions required significant slack in the hydraulic fluid line leading to the implement. This excess line has heretofore been required to allow for the implement to move from one extreme position such as fully racked, to another extreme position such as fully dumped. In so doing, when the implement was in the fully racked position, a significant sag would result where the excess hydraulic line would loop or accumulate below the level of the work arm. While effective, this sag was subject to significant wear by dragging along the ground or other work surface. In addition, not only would the sag be subjected to wear, but it could also become entangled or be otherwise snagged within and around the various moving components of the work machine.

The work machine 20 of the present disclosure, on the other hand, greatly improves upon this prior art design. More specifically, the unique design of the work machine substantially reduces any sag in the hydraulic lines, while still enabling a full range of motion for the work implements. It does so, while at the same time preventing undue wear and tear on the hose because the abatement of the sag hinders the hose from dragging on the ground or other work surface with which the work machine 20 comes into contact.

Referring now to FIGS. 2-5, the work machine 20 of the present disclosure is shown in more detail. The work machine 20 is shown to include the work arm 28 with distal end 32 where a work implement interface 40 (often referred to as a “quick connect”) is pivotably connected at a second pivot point 42. The work implement interface 40 enables quick connection of any of the aforementioned work implements 34.

Along work arm 28, a first hydraulic fluid line 43 is closely mounted and extends from the hydraulic pump 31 to a first junction 44. The first hydraulic fluid line 43 may be rigid conduit as shown, or flexible hose. A second hydraulic fluid line 46 may then extend from the first junction 44 to a hydraulic swivel coupling 47 provided at the center of rotation 42. The second hydraulic fluid line 46 may be flexible hose as shown, or rigid conduit. Alternatively, the first hydraulic fluid line 43 and second hydraulic fluid line 46 may be provided as one unitary conduit. A third hydraulic fluid line 48 may then extend from the hydraulic swivel coupling 47 to the work implement 34. The third hydraulic fluid line 48 may be rigid conduit as shown, or flexible hose.

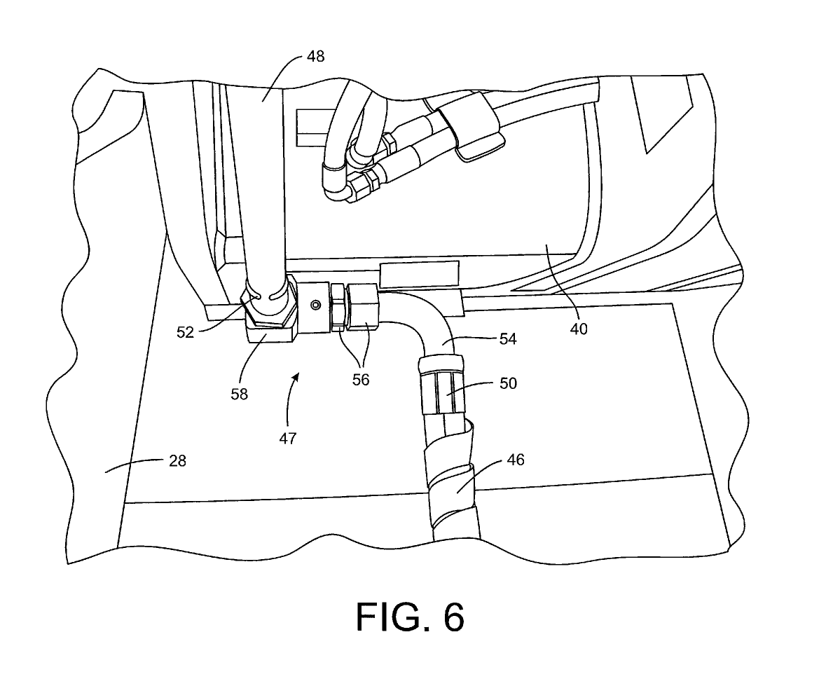

As shown best in FIG. 6, the hydraulic swivel coupling 47 may include an inlet 50 and an outlet 52 provided at a right angle relative to one another. Moreover, the inlet 50 and outlet 52 allow the hoses connected thereto to freely rotate while still maintaining a tight hydraulic seal. It may do so by providing a right angle bend conduit 54 extending from inlet 50, and a series of compression fittings or nuts 56 leading to another right angled fitting 58 and ultimately outlet 52. Other mechanical arrangements for allowing swiveling action between hydraulic lines is certainly possible and encompassed within the scope of this disclosure.

Not only does such a swivel coupling 47 enable the second hydraulic fluid line 46 to rotate relative to the third hydraulic fluid line 48, but mounting the swivel coupling 47 at the second pivot pilot 42, the work implement 34 is able to rotate through its full range of motion without producing significant sag in either line to thus keep lines 46 and 48 out of harm's way, and providing significant excess hose to accommodate such motion. In addition, when disconnected from lines 46 and 48, while likely never needing to, the hydraulic swivel coupling 47 could allow for 360° of free rotation, and at least 180° of rotation when connected between the respective lines.

This is perhaps best shown in a comparison between the various work implement positions of FIGS. 2-5. In FIG. 2, the work implement interface 40, and thus work implement (not shown), is rotated to one extreme of its range of motion referred to as fully racked. For example, if the implement is a bucket, this might be the position used after the bucket is filled with soil or other cargo, and then pulled back against the work arm to securely hold the soil while the work machine transports it to another location for dumping. In such a position, it can be seen that the hydraulic fluid lines produce little sag, whereas by contrast, prior art designs would produce their maximum amount of sag.

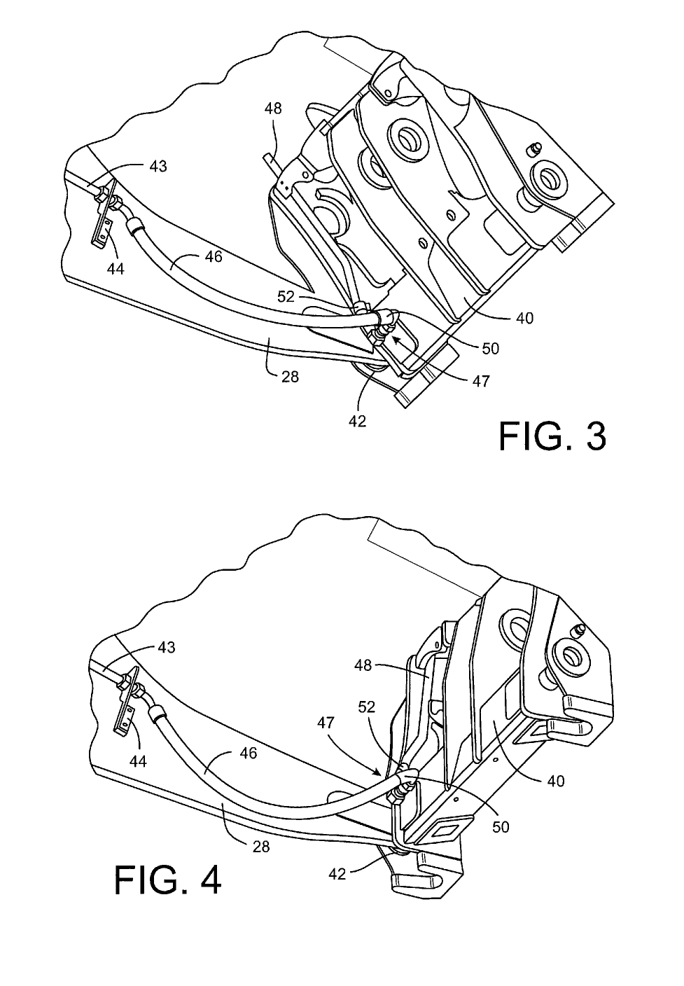

Turning to FIG. 3, the work implement interface 40 is shown rotated to a first intermediate position away from the work arm. Similarly, in FIG. 4, the work implement interface 40 is shown rotated to a second intermediate position even further away from the work arm. In both positions, it can be seen that the hydraulic fluid lines produce little sag.

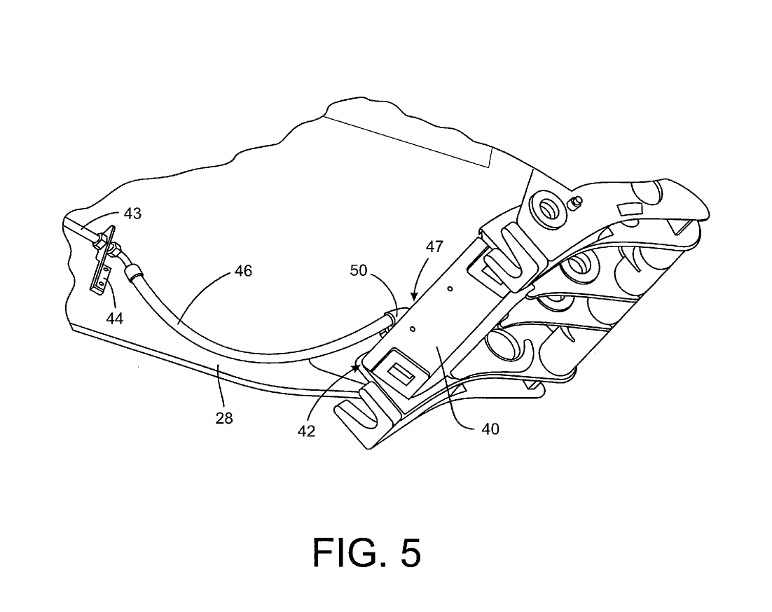

Finally, turning to FIG. 5, the other extreme position of rotation is shown. This position, referred to as fully dumped, again causes little sag in the hydraulic fluid lines. Continuing the example above, this position might be achieved when the bucket is dumping its load. The implement in such an example may be able to rotate 180° or more between the fully racked and fully dumped position. In prior art work machines, this would correspond to the position where the hydraulic fluid lines are stretched as far as possible, and in some instances even limiting such rotational movement of the implement.

### INDUSTRIAL APPLICABILITY

In general, the teachings of the present disclosure provide applicability in a number of industrial settings including, but not limited to, work machines used in construction, agriculture, and industry. For example, the work machines may be, but are not limited to, loaders, excavators, compactors, track-type tractors, skid steers, telehandlers, and motor graders. Such machines can be provided with little excess hydraulic line being required, little sagging in the hydraulic lines being witnessed at any of its rotational positions, and with a full range of rotation enabled for all first, second, third and more level hydraulic functions.

In operation, the present disclosure does so by extending a first hydraulic fluid line from a hydraulic pump of the work machine down a work arm to a distal end of the work arm. A second hydraulic fluid line is also extended from the work implement down to a pivot point between the work arm and the work implement. A hydraulic swivel coupling is then provided at the pivot point of rotation to connect the first and second hydraulic fluid hoses. In so doing, the implement is able to fully rotate between a fully racked and fully dumped position, without producing significant sag in the hydraulic lines, without limiting the range of motion of the work implement, and while enabling operation of first, second, third and beyond levels of hydraulic operation.

What is claimed is:

1. A work machine, comprising:
a chassis;
a work arm pivotally attached to the chassis at a first pivot point;
a work implement pivotally attached to the work arm at a second pivot point;
a hydraulic fluid pump supported by the chassis;
a first hydraulic fluid line extended from the pump to the second pivot point;
a second hydraulic fluid line extended from the work implement to the second pivot point; and
a hydraulic swivel coupling at the second pivot point, the first and second hydraulic fluid lines being connected to the hydraulic swivel coupling.

2. The work machine of claim 1, wherein the work machine is selected from the group of work machines consisting of loaders, excavators, compactors, track-type tractors, skid steers, telehandlers, and motor graders.

3. The work machine of claim 2, wherein the work implement is selected from the group of implements consisting of augers, blades, brooms, buckets, cold planers, couplers, cutters, forks, handlers, grapplers, plows, rakes, thumbs, vibratory compactors, shears, rippers, scoops, backhoes, brushcutters, mulchers, snow blowers, stump grinders, tillers, trenchers, wheel saws, carriages, lifting hooks, hoppers, winches and scarifiers.

4. The work machine of claim 1, wherein the work implement is able to rotate at least 180° relative to the work arm.

5. The work machine of claim 1, wherein the second hydraulic fluid line is a third function hose.

6. The work machine of claim 1, wherein the first and second hydraulic fluid lines are held close to the work arm and work implement, respectively, and avoid dragging on ground upon which the work machine rests.

7. The work machine of claim 1, wherein the hydraulic swivel coupling enables at least 180° of rotation between the first and second hydraulic fluid lines.

8. A work implement adapted to be connected to a work machine having a source of hydraulic fluid, the work implement comprising:
a pivot point connectable to a work machine;
a third function tool operating associated with the implement and adapted to employ hydraulic fluid;
a hydraulic fluid line extending from the third function tool to the pivot point; and
a hydraulic swivel coupling connected to the hydraulic fluid line at the pivot point.

9. The work implement of claim 8, wherein the work implement is selected from the group of work implements consisting of augers, blades, brooms, buckets, cold planers, couplers, cutters, forks, handlers, grapplers, plows, rakes, thumbs, vibratory compactors, shears, rippers, scoops, backhoes, brushcutters, mulchers, snow blowers, stump grinders, tillers, trenchers, wheel saws, carriages, lifting hooks, hoppers, winches and scarifiers.

10. The work implement of claim 8, wherein the work implement is rotatable at least 180° relative to a work machine.

11. The work implement of claim 8, wherein the hydraulic fluid line is a third function line.

12. The work implement of claim 8, wherein the hydraulic fluid line is held close to the work implement and avoids dragging upon ground upon which the work machine rests.

13. The work implement of claim 8, wherein the hydraulic swivel coupling enables 180° of rotation of the hydraulic fluid line.

14. A method of connecting work implements to a hydraulic fluid source of a work machine, comprising:
extending a first hydraulic fluid line from a hydraulic fluid pump to a pivot point between the work machine and the work implement;
extending a second hydraulic fluid line from a component of the work implement needing hydraulic fluid to the pivot point; and
interconnecting the first and second lines with a hydraulic swivel coupling at the pivot point.

15. The method of claim 14, wherein the work machine is selected from the group of work machines consisting of loaders, excavators, compactors, track-type tractors, skid steers, telehandlers, and motor graders.

16. The method of claim 14, wherein the work implement is selected from the group of implements consisting of augers, blades, brooms, buckets, cold planers, couplers, cutters, forks, handlers, grapplers, plows, rakes, thumbs, vibratory compactors, shears, rippers, scoops, backhoes, brushcutters, mulchers, snow blowers, stump grinders, tillers, trenchers, wheel saws, carriages, lifting hooks, hoppers, winches and scarifiers.

17. The method of claim 14, wherein the work implement is able to rotate at least 180° relative to the work machine.

18. The method of claim 14, wherein the second hydraulic fluid line is a third function line.

19. The method of claim 14, wherein the first and second hydraulic fluid lines are held close to the work machine and work implement, respectively, and avoid dragging on ground upon which the work machine rests.

20. The method of claim 14, wherein the hydraulic swivel coupling enables at least 180° of rotation between the first and second hydraulic fluid lines.
